(19) United States
(12) Patent Application Publication
(10) Pub. No.: US 2010/0065222 A1
(43) Pub. Date: Mar. 18, 2010

(54) HAND LABELER

(76) Inventor: Toshikazu KAWADA, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/493,392

(22) Filed: Jun. 29, 2009

(30) Foreign Application Priority Data
Sep. 18, 2008 (JP) 2008-239258

(51) Int. Cl. B29C 65/00

(52) U.S. Cl. 156/543

(57) ABSTRACT

A hand labeler having a peel member and a peel roller on the front-end side of the peel member to feed out label smoothly. The peel roller is used to peel off the label. The peel roller is made of a pipe having a diameter smaller than the thickness of a front-end portion of the peel member. The peel roller is rotatably pivoted to a shaft, which is mounted on the front-end side of the peel member with a given space therebetween.

### BACKGROUND OF THE INVENTION

1. Field of the Invention

The present invention relates to improvements in a hand labeler for causing labels used for price marking or for other purpose to be stuck onto merchandise.

2. Prior Art

A conventional hand labeler of this type has a handle lever 3 rotatably mounted under a grip 2 on a labeler body 1, for example, as shown in FIG. 7. A label holding member 4 rotatably holds a label wound around it. A peel member 7 has a base portion 7a held in position on the labeler body 1 by a shaft 8. An inner first guide surface 7b and an outer second guide surface 7c to guide the label are formed on the peel member 7. The peel member 7 tapers at its front end to which a peel roller 10 is mounted.

Label can be peeled off more effectively as the angle of the front end of the peel member 7 becomes more acute. If the front-end portion is kept held when the belt-like label tape-backing sheet is folded back, strong resistance is encountered. This makes it difficult to feed out the label. Therefore, the peel roller 10 for solving the difficulty of this operation is adopted (see, JP-A-2006-69664).

However, in the aforementioned prior art hand labeler, a bearing 7d₁ for mounting the shaft 10a of the peel roller 10 is necessary on the side surface of the front end of the peel member 7 as shown enlarged in FIG. 6. Also, it is required to use of the peel roller 10 having a diameter larger than the outside diameter of the bearing 7d₁. For these reasons, the belt-like tape-backing sheet comes into contact with the outer surface of the bearing 7d₁. This creates the problem that it is difficult to feed out the label smoothly. In addition, the peel roller 10 projects from the outer surface of the bearing 7d₁ and, accordingly, it is very difficult to feed out thin label smoothly.

In other words, where the peel roller 10 for which the bearing 7d₁ is essential adopted, if the belt-like tape-backing sheet is set within the width of the peel roller 10, and if a peeling operation is performed, the tape-backing sheet is moved to one side. As a result, it is inevitable that the backing sheet rides against the bearing 7d₁, thus increasing the resistance of the belt-like backing sheet. Accordingly, heavier load is imposed in manipulating the handle lever 3. In this way, the label is fed out under deteriorated conditions. Hence, the level of quality of the peel member 7 determines the performance of the hand labeler.

### SUMMARY OF THE INVENTION

In view of the foregoing problems with the prior art, the present invention has been made. It is an object of the present invention to provide a hand labeler that dispenses with the prior art bearing and which, if the used label is thin, can reliably peel off the label and smoothly feed it out.

Accordingly, the present invention provides a hand labeler having a peel roller for peeling off label on a front-end side of a peel member. The peel roller is made of a pipe having a diameter smaller than the thickness of a front-end portion of the peel member. The peel roller is rotatably pivoted to a shaft that is mounted so as to be spaced a given distance from the front end of the peel member.

Preferably, the shaft is inserted in mounting holes formed around the front end of the peel member while both ends of the shaft are bent through an appropriate angle. The shaft is held to one or more support portions protruding forwardly from the front end of the peel member.

Preferably, the support portions hold the shaft stationary via holes or recessed portions on the front side. Also, the peel roller is preferably made of a pipe having a diameter of 0.3 to 2.4 mm.

The hand labeler of the present invention is configured as described so far. Use of the peel roller having a diameter smaller than the thickness of the front-end portion of the peel member makes it possible to peel off the label reliably even if the label is thin. Consequently, there is the advantage that continuous label in the form of a roll can be fed out more smoothly.

Especially, the small-diameter peel roller that could not have been heretofore adopted can be mounted. Therefore, the hand labeler can feed out very thin label (e.g., having a thickness of about 1/100 mm) stuck continuously on a belt-like label-tape backing sheet after peeling off the label reliably. In the past, such very thin label has been very difficult to peel off. In this way, the novel hand labeler can feed out label more smoothly. Furthermore, the hand labeler is simple in structure and hence adapted for mass production. The hand labeler can be offered to consumers at low cost. In this manner, great practical merits can be obtained by implementing the present invention.

### BRIEF DESCRIPTION OF THE DRAWINGS

FIG. 1 is a side elevation view showing main portions of a hand labeler according to the present invention;

FIG. 2 is a perspective view of main portions of the hand labeler;

FIG. 3 is a perspective view similar to FIG. 2, but in which a detecting pawl-mounting member has been removed;

FIG. 4A is an exploded perspective view of main portions of a peel member included in the hand labeler;

FIG. 4B is a fragmentary vertical cross section view showing a front-end portion of the peel member;

FIG. 5 is a perspective view of a label feeding mechanism included in the hand labeler;

FIG. 6 is a side elevation view showing main portions of the prior art hand labeler; and

FIG. 7 is a side elevation view showing the prior art hand labeler.

### DETAILED DESCRIPTION OF THE PREFERRED EMBODIMENTS

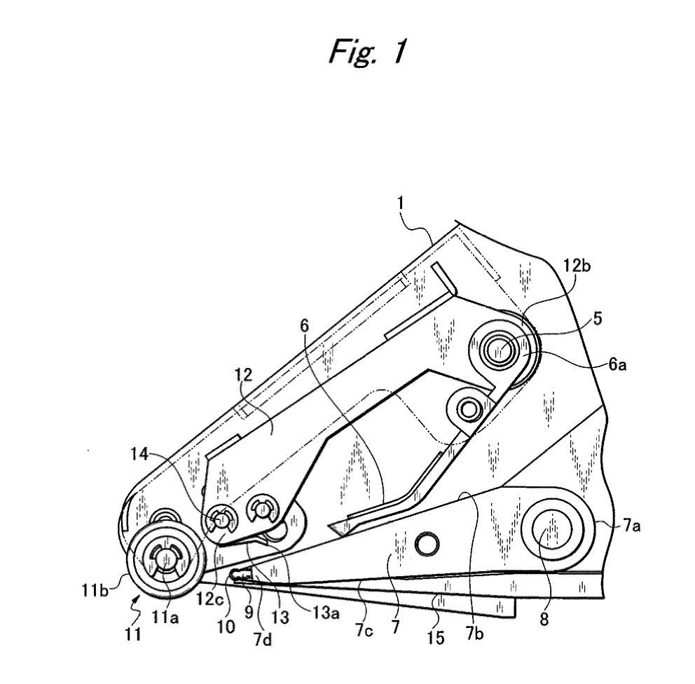

FIGS. 1-5 show a hand labeler according to one embodiment of the present invention. To facilitate understanding, those components that are identical with their respective counterparts of the above-described prior art are indicated by the same reference numerals as in the description of the prior art. Only different components are indicated by novel reference numerals and will be described below. A fixed shaft 5 is held at right angles to the vertical wall surface of the labeler body 1. A labeler presser 6 and a detecting pawl-mounting member 12 (described later) are swingably mounted to the fixed shaft 5.

The label presser 6 has a base portion 6a fitted over the outer periphery of the fixed shaft 5. The part of the presser starting from its intermediate portion and ending with the front end is held along the first guide surface 7b (described later) of the peel member 7. Label is fed out smoothly along a desired route.

The base portion 7a of the peel member 7 is held to the labeler body 1 at a given position by the shaft 8. The peel member 7 has the inner first guide surface 7b and the outer second guide surface 7c that guide the label. An acute angle is made between the guide surfaces 7b and 7c and thus the peel member 7 tapers. The peel member is mounted so as to guide the label smoothly.

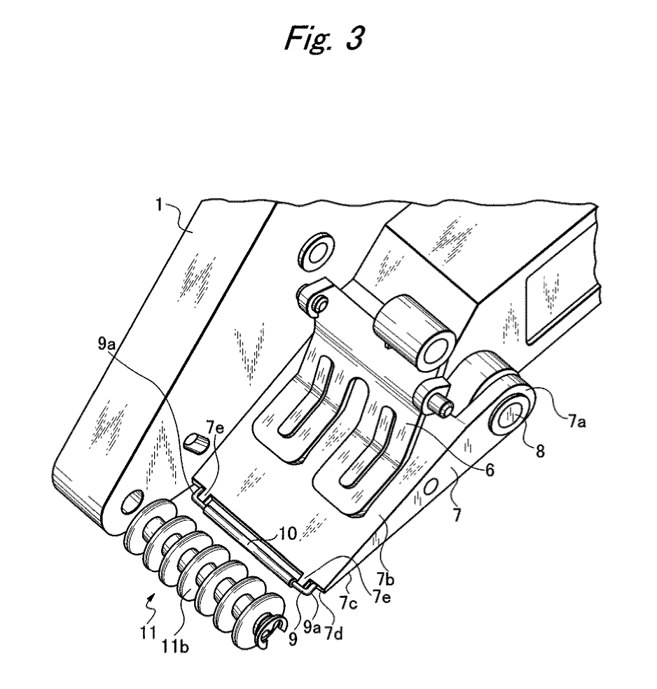

As shown in FIG. 3, a shaft 9 having a small diameter is stretched over the front-end portion 7d of the peel member 7 via a pair of support portions 7e. The peel roller 10 made of a small pipe is rotably and loosely fitted over the small shaft 9. The peel roller 10 is made of a small cylindrical pipe having a diameter of 0.3 to 2.4 mm smaller than the diameter of the prior art pipe.

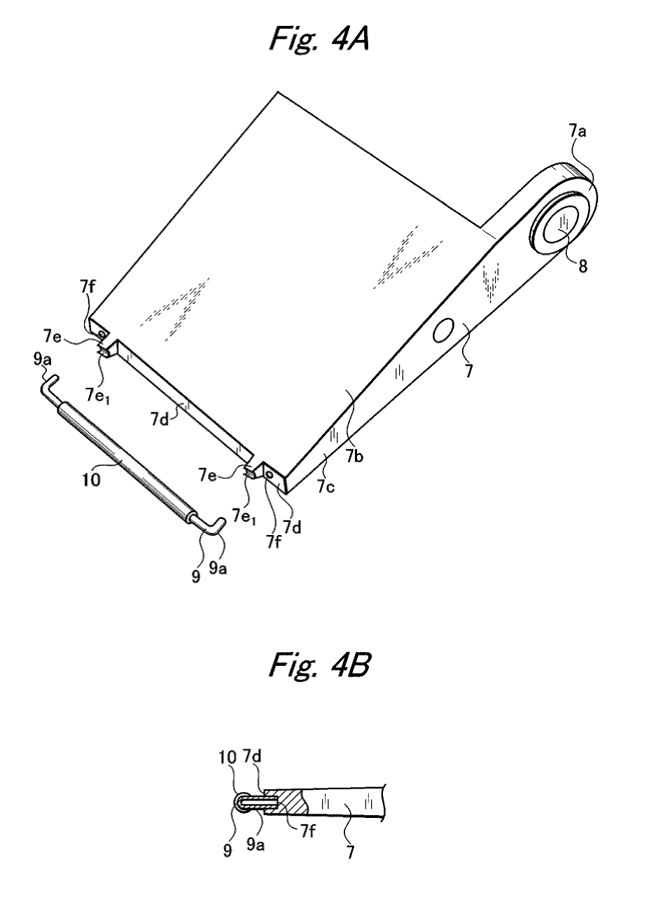

As shown in FIGS. 4A and 4B, the shaft 9 has connecting portions 9a each of which has both loose ends bent at right angles. The peel member 7 has mounting holes 7f around the front end. The connecting portions 9a are inserted and held in the holes 7f. The shaft 9 is held fixed via recessed portions 7e₁ formed around the front ends of the support portions 7e. The peel roller 10 of small diameter is spaced from the front-end portion 7d of the peel member 7.

The pipe of the peel roller 10 is chiefly made of a metal (metallic pipe). Obviously, the roller may be made of other appropriate material such as synthetic resin, rubber, or ceramics. A pipe much thinner than the prior art peel roller having a diameter of about 2.5 mm can be used.

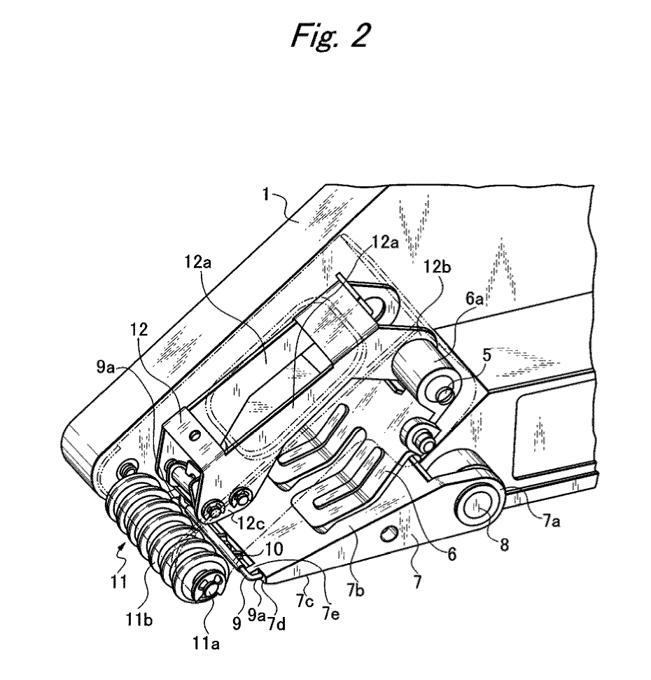

On the other hand, a pressure roll 11 presses label peeled from belt-like label-tape backing sheet (not shown) against an object to stick the label. The pressure roll 11 has a roll shaft 11a disposed substantially parallel to the fixed shaft 5 and a pressing portion 11b protruding from the outer surface of the roll shaft 11a, the pressing portion 11b being made of a resilient member (see FIG. 2).

The detecting pawl-mounting member 12 has both arm portions 12a (see FIG. 2) disposed parallel to each other with a given space therebetween. The arm portions 12a have base portions 12b, which are rotataby supported to the fixed shaft 5. The detecting pawl-mounting member 12 has front ends 12c biased toward the belt-like label tape-backing sheet. A detecting pawl 13 (see FIG. 1) acting also as a label presser is mounted to the front ends 12c.

As shown in FIGS. 1 and 2, the detecting pawl-presser 13 is firmly held to a shaft 14 stretched across the front-end portion 12c of the detecting pawl-mounting member 12 so as to be angularly displaceable. A label-pressing portion 13a is formed integrally with the front end of the detecting pawl-presser 13 and biased into abutment with the belt-like label tape-backing sheet.

In other words, the detecting pawl-presser 13 is so mounted that, when the handle lever 3 is in open state, the detecting pawl-presser 13 is above the front end of the label to be peeled off and, when the label is slightly fed out by the operation of the handle lever 3 from open state to dosed state, the detecting pawl-presser 13 feeds out label forwardly while in abutment with the label. If the detecting pawl-presser 13 comes into abutment with the front end of the next label, the pawl-presser 13 is angularly displaced and the feeding of the label is stopped. Obviously, similar operations can be performed by reversing the order of opening and dosing actions of the handle lever 3.

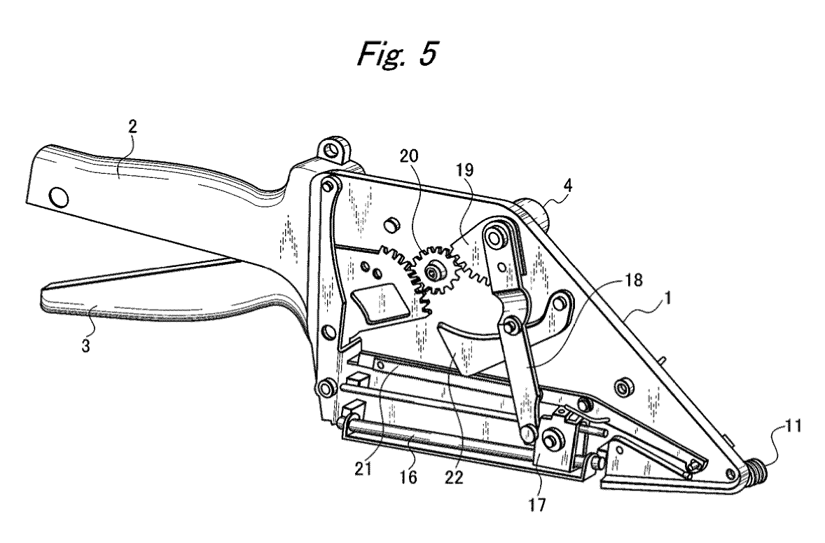

In the hand labeler of the invention constructed in this way, if the handle lever 3 is operated to switch it from open state to dosed state relative to the grip 2, during going excursion of a feeding pawl 17 sliding along a guide rod 16 as shown in FIG. 5, the label tape-backing sheet is caught between the front end of each tooth of pawl members (not shown) and a receipt guide plate (not shown) of a door body 15 (see FIG. 1). Thus, the label is fed out.

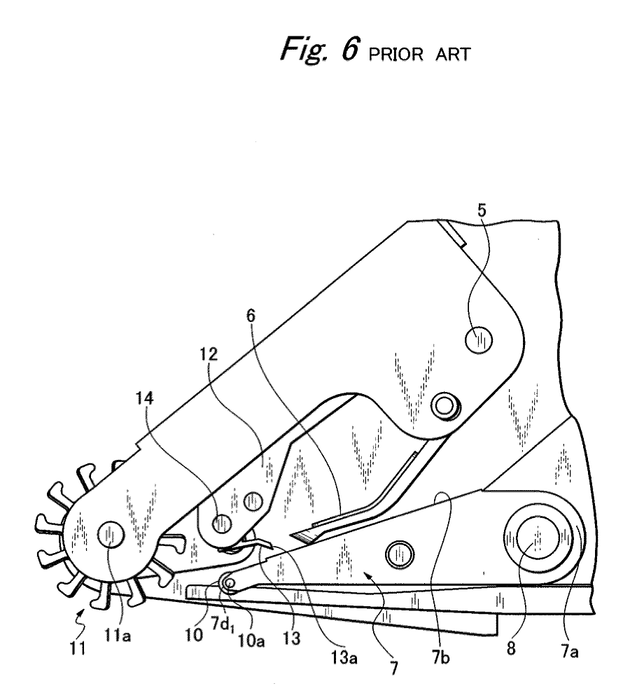

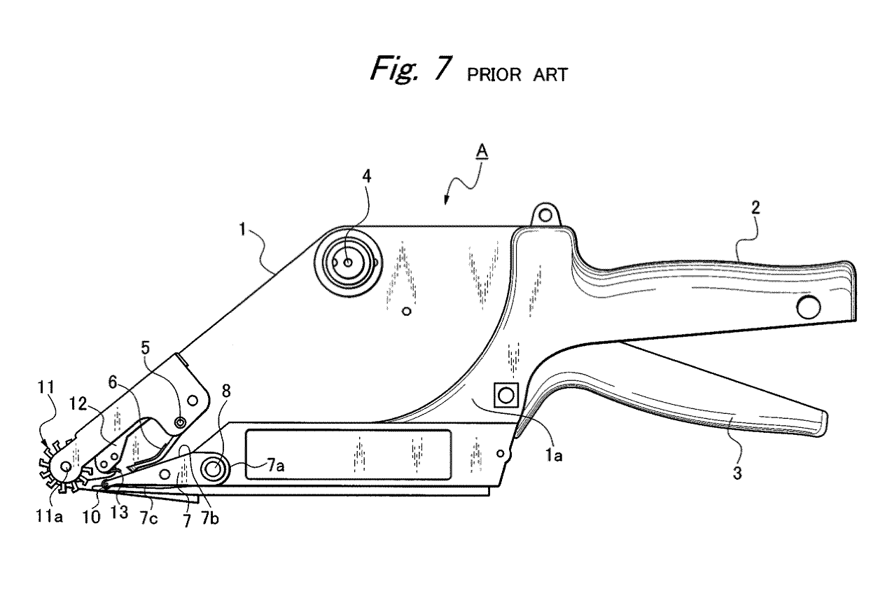

At this time, the belt-like label tape-backing sheet can be changed in direction by the peel roller 10 of the peel member 7. The roller 10 is made of a pipe with a small diameter and does not need the bearing 7d₁ (see FIG. 6) of large diameter as in the prior art In other words, the belt-like label tape-backing sheet does not ride against the bearing 7d₁, unlike in the prior art. Accordingly, the belt-like label tape-backing sheet can be fed out smoothly without resistance. The label adhesively bonded to the belt-like backing sheet attempts to travel straight without changing direction, and the front end is forcibly peeled off. As a result, the label can be pressed against and bonded to the target. In FIG. 5, a segmental gear 19 meshes with a tape-feeding lever 18 and with an intermediate gear 20. Also shown are an adjustment stop lever 21 and a disengaging member 22.

It is to be understood that the hand labeler of the present invention is not limited to the present embodiment. Rather, the design of the hand labeler can be modified at will within the scope of the object of the invention. The invention embraces all of such modifications.

For example, in the present embodiment, both ends of the shaft 9 are inserted and held in the mounting holes 7f around the front end of the peel member 7 while being bent at right angles. The both ends may be straightened and pivot-mounted to the mutually opposite support portions 7e via holes (not shown) without bending the connecting portions 9a. Furthermore, the both ends may be held to the front-end portion 7d using only the connecting portions 9a bent at right angles without using the support portions 7e.

What is claimed is:

1. A hand labeler having a peel member and a peel roller for peeling off label, the peel roller being located on a front-end side of the peel member,
wherein said peel roller is made of a pipe having a diameter smaller than the thickness of a front-end portion of the peel member, and
wherein the peel roller is rotatably pivoted to a shaft that is mounted so as to be spaced a given distance from the front end of the peel member.

2. A hand labeler as set forth in claim 1, wherein said shaft is inserted and mounted in mounting holes formed around the front end of the peel member while both ends of the shaft are bent substantially at right angles, and wherein the shaft is held to one or more support portions protruding forward from the front-end portion of the peel member.

3. A hand labeler as set forth in claim 2, wherein said shaft is held fixed via holes or recessed portions on front-end sides of the support portions.

4. A hand labeler as set forth in claim 1, wherein said peel roller is made of a pipe having a diameter of 0.3 to 2.4 mm.
